(19) United States
(12) Patent Application Publication
(10) Pub. No.: US 2022/0076860 A1
(43) Pub. Date: Mar. 10, 2022

(54) DATA LINE WITH MEMORY FUNCTION AND METHOD FOR CONTROLLING THE SAME

(71) Applicant: Shenzhen Kung Fu Niu Electronics Co., Ltd., Shenzhen (CN)

(72) Inventor: Shaolin Su, Shenzhen (CN)

(73) Assignee: Shenzhen Kung Fu Niu Electronics Co., Ltd.

(21) Appl. No.: 17/331,655

(22) Filed: May 27, 2021

(30) Foreign Application Priority Data
Sep. 7, 2020 (CN) 202010930991.9

(51) Int. Cl. H01B 7/00; H01R 13/66; H01R 31/06; H05B 3/00; H05B 1/02

(52) U.S. Cl. CPC H01B 7/0009; H01R 13/665; H05B 2203/035; H05B 3/0004; H05B 1/0227; H01R 31/065

(57) ABSTRACT

The present invention provides a data line with a memory function. The data line includes a connection cable and a plug connector arranged on the connection cable; the connection cable includes a memory alloy wire arranged along its length direction, and the memory alloy wire is electrically connected with the plug connector; the plug connector is configured to be connected to an electronic device, and the electronic device provides a current for the memory alloy wire, and the current can raise the temperature of the memory alloy wire to reach a memory deformation temperature. The connection cable of the present invention can automatically change its shape.

### TECHNICAL FIELD

The present invention relates to a data line, and in particular to a data line with a memory function and a method for controlling the same.

### BACKGROUND

A data line is an intermediate connection cable connecting two electronic devices (such as a mobile phone and a computer, a mobile phone and a charger, etc.). An existing data line includes a surface layer and a conductive wire arranged within the surface layer, and the data line with such a structure cannot automatically change its shape.

### SUMMARY

Therefore, it is necessary to provide a data line with a memory function and a method for controlling the same, and the connection cable can automatically change its shape.

The present invention provides a data line with a memory function. The data line includes a connection cable and a plug connector arranged on the connection cable; the connection cable includes a memory alloy wire arranged along its length direction, and the memory alloy wire is electrically connected with the plug connector; the plug connector is configured to be connected to an electronic device, the electronic device provides a current for the memory alloy wire, and the current can raise a temperature of the memory alloy wire to reach a memory deformation temperature.

Preferably, the data line includes a connection cable, a plug connector arranged on the connection cable, and a control circuit electrically connected with the plug connector; the connection cable includes a conductive wire and a memory alloy wire which are arranged along the length direction of the connection cable, and the conductive wire and the memory alloy wire are electrically connected with the control circuit; the plug connector is configured to be connected to an electronic device, the electronic device provides a current for the conductive wire, and the memory alloy wire so as to raise a temperature of the memory alloy wire to reach the memory deformation temperature.

Preferably, the control circuit controls a voltage to be changed to reach a predetermined voltage so that a suitable current passes through the memory alloy wire and thus the temperature of the memory alloy wire is raised to reach the memory deformation temperature, when the control circuit does not recognize within a predetermined time period that the current passes through the conductive wire.

Preferably, the control circuit controls the voltage to be changed to reach the predetermined voltage so that a suitable current passes through the memory alloy wire and thus the temperature of the memory alloy wire is raised to reach the memory deformation temperature, when a period of time that the conductive wire is connected with the plug connector reaches the predetermined time period.

Preferably, the control circuit controls the voltage to be decreased so that the temperature of the memory alloy wire is decreased and thus the temperature of the memory alloy wire is lower than the memory deformation temperature, when the predetermined voltage is reached for the predetermined time period.

Preferably, the control circuit disconnects the electrical connection between the memory alloy wire and the electronic device, when the predetermined voltage is reached for the predetermined time period.

Preferably, before the control circuit controls the voltage to be changed, the control circuit first disconnects the connection between the plug connector and the conductive wire, and connects the plug connector with the memory alloy wire.

The present invention provides a method for controlling a data line with a memory function. The data line includes a connection cable, a plug connector arranged on the connection cable, and a control circuit electrically connected with the plug connector; the connection cable includes a conductive wire and a memory alloy wire which are arranged along a length direction of the connection cable, and the conductive wire and the memory alloy wire are electrically connected with the control circuit; the method includes:

providing, by an electronic device, a current for the conductive wire when the plug connector is connected to the electronic device; and

controlling, by the control circuit, a voltage to be changed to reach a predetermined voltage so that a suitable current passes through the memory alloy wire and thus a temperature of the memory alloy wire is raised to reach a memory deformation temperature, when the control circuit does not recognize within a predetermined time period that the current passes through the conductive wire.

The present invention provides a method for controlling a data line with a memory function. The data line includes a connection cable, a plug connector arranged on the connection cable, and a control circuit electrically connected with the plug connector; the connection cable includes a conductive wire and a memory alloy wire which are arranged along a length direction of the connection cable, and the conductive wire and the memory alloy wire are electrically connected with the control circuit; the method includes:

providing, by an electronic device, a current for the conductive wire when the plug connector is connected to the electronic device; and

controlling, by the control circuit, a voltage to be changed to reach a predetermined voltage so that a suitable current passes through the memory alloy wire and thus a temperature of the memory alloy wire is raised to reach a memory deformation temperature, when a period of time that the conductive wire is connected with the plug connector reaches a predetermined period of time.

Preferably, before the control circuit controls the voltage to be changed, the control circuit first disconnects the connection between the plug connector and the conductive wire, and connects the plug connector with the memory alloy wire.

The connection cable of the data line of the present invention includes a memory alloy wire arranged along its length direction. When the plug connector is connected with an electronic device, the current can pass through the memory alloy wire, and because the memory alloy wire has a certain resistance, a temperature of the memory alloy wire is raised to reach a memory deformation temperature, and then the memory alloy wire is deformed to a memory shape, so that the connection cable can also be deformed to the memory shape at the same time.

### BRIEF DESCRIPTION OF THE DRAWINGS

FIG. 1 is a schematic diagram of a structure according to a first embodiment of the present invention.

FIG. 2 is a schematic diagram of a structure according to a second embodiment of the present invention.

FIG. 3 is a principle diagram of FIG. 2.

FIG. 4 is a flow chart of a method according to the first embodiment of the present invention.

FIG. 5 is a flow chart of a method according to the second embodiment of the present invention.

### DETAILED DESCRIPTION

The technical solutions in the embodiments of the present invention will be clearly and completely described below in conjunction with the accompanying drawings in the embodiments of the present invention. Obviously, the described embodiments are only a part of the embodiments of the present invention, rather than all the embodiments.

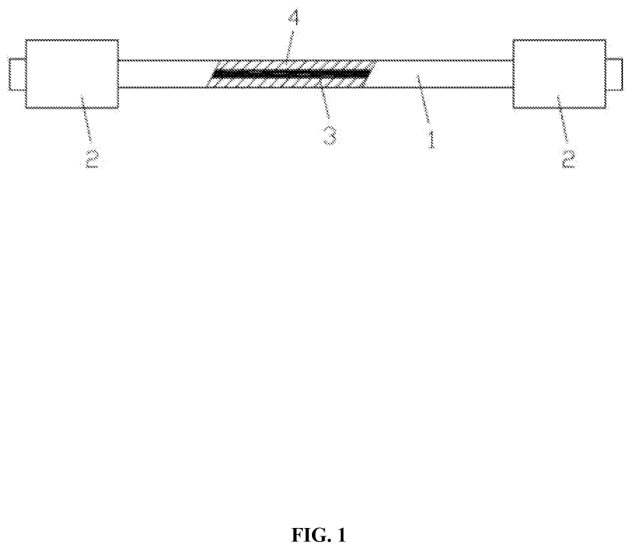

As shown in FIG. 1, a first embodiment of the present invention provides a data line with a memory function. The data line includes a connection cable 1 and two plug connectors 2 arranged on the connection cable 1. The two plug connectors 2 are respectively configured to be connected to one electronic device, so that the two electronic devices are electrically connected via the connection cable 1. The two plug connectors 2 may be selected according to different standards, and may be for example USB to micro, USB to Lightning, USB to type-c, USB to DC, type-c to micro, type-c to Lightning, type-c to type-c, charger to micro, charger to Lightning, charger to type-c, etc. In the figure, the right side is the input terminal, and the left side is the output terminal.

The connection cable 1 includes a memory alloy wire 3 and a surface layer 4 covering the memory alloy wire 3 which are arranged along a length direction of the connection cable. The surface layer 4 may be made of, for example, a compound material such as environmentally friendly PC or ABS. The memory alloy wire 3 may be used as a conductive wire 5 to transmit electrical energy and/or communication signals. Two ends of the memory alloy wire 3 are electrically connected with one plug connector 2 respectively.

The memory alloy wire 3 may be made of but not limited to nickel-titanium alloy, and may also be made of nickel-aluminum alloy, for example. Those skilled in the art may obtain an alloy wire with a memory function by proportioning the components of the alloy. For example, in the nickel-titanium alloy, the proportion of nickel-titanium and/or the proportion of heteroelements may be changed to change the memory deformation temperature (phase transition temperature), such as 20° C.-40° C., 45° C.-90° C., 5° C.-15° C., etc., so as to obtain the appropriate memory deformation temperature (for example, 45 ° C.). according to a usage environment temperature of the data line. Likewise, for example, in the nickel-titanium alloy, the proportion of nickel-titanium and/or the proportion of heteroelements is changed to change the electrical properties of the memory alloy wire 3, so that the memory alloy wire 3 can transmit electrical energy and/or communication signals.

Taking one electronic device as a charging head and another electronic device as a mobile phone as an example, when the two plug connectors 2 are plugged into the charging head and the mobile phone, the current flowing into the charging head flows from the memory alloy wire 3 into the mobile phone, thereby charging the mobile phone. The charging head provides a current for the memory alloy wire 3 while providing a current for the mobile phone, so that a temperature of the memory alloy wire 3 is raised. When the temperature of the memory alloy wire 3 is raised to reach a memory deformation temperature, the memory alloy wire 3 will be automatically deformed.

The deformed shape of the memory alloy wire 3 may be pre-shaped. In order to facilitate the charging by the data line, the memory alloy wire 3 may be pre-shaped into a regular shape at the memory deformation temperature, which is not limited here. When the temperature of the memory alloy wire 3 is raised to reach the memory deformation temperature, the memory alloy wire 3 will be automatically deformed into the pre-shaped regular shape, which is convenient for the arrangement of the data line after charging.

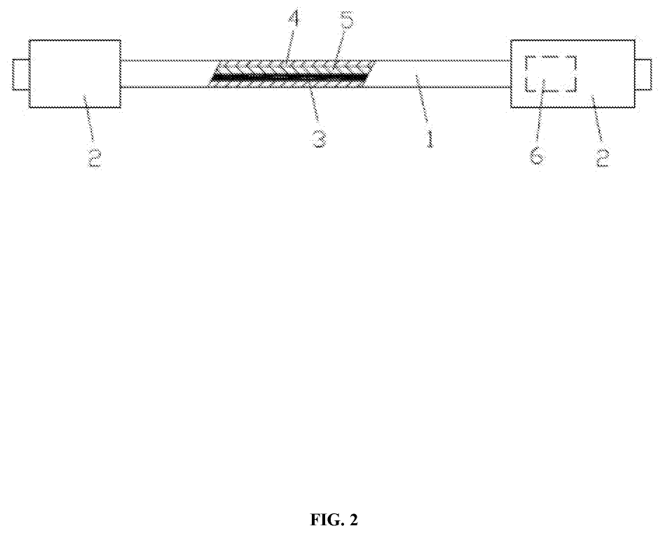

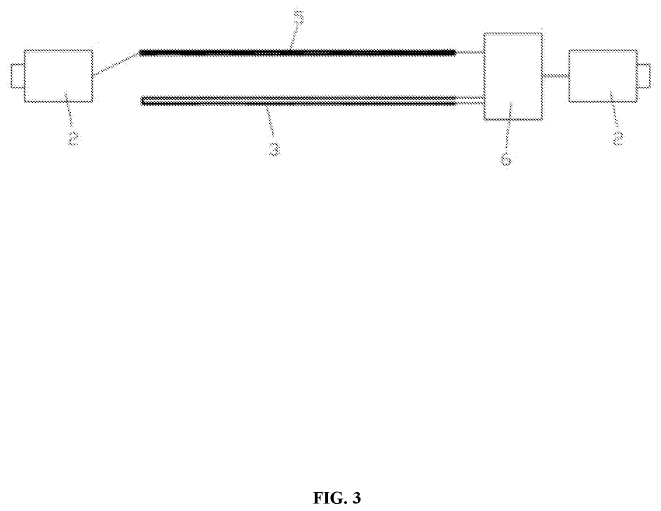

As shown in FIG. 2 and FIG. 3, a second embodiment of the present invention provides a data line with a memory function. The main difference from the first embodiment is that the data line with a memory function provided in this embodiment further includes a conductive wire 5 and a control circuit 6. The conductive wire 5 is used to transmit electrical energy and/or communication signals. The conductive wire 5 may include a power wire and/or a signal wire, and the memory alloy wire 3 is mainly used for deformation. Of course, similar with the first embodiment, the memory alloy wire 3 may also be used as a current signal and data carrier. The control circuit 6 may be integrated on a control board, and the control board is arranged on the data line, for example, the control board is arranged inside a plastic terminal of the plug connector 2.

The conductive wire 5 and the memory alloy wire 3 are electrically connected with the control circuit 6. When the memory alloy wire 3 is connected with the control board, an end of the memory alloy wire 3 may be bent to form an L shape, is then inserted into the control board and then soldered with tin (or is fixed on the circuit board by a metal terminal of other specific shape to be energized and is not easy to fall off) to achieve the purpose of being energized, and is not easy to fall off. Then, a finished connector mold of the charging data line is injected with environmentally friendly PC or ABS (or other materials) by an injection molding machine to be fixed and be made more secure.

In FIG. 2 and FIG. 3, the right side is the input terminal, and the left side is the output terminal. The control board may be integrated into the input terminal.

When the plug connector 2 is connected to an electronic device, the electronic device can provide a current for the conductive wire 5 and the memory alloy wire 3. The control circuit 6 controls the circuit, so that the electronic device may provide a current for the conductive wire 5 and the memory alloy wire 3 at the same time, or may provide a current for the conductive wire 5 and the memory alloy wire 3 separately.

If the electronic device provides a current for the conductive wire 5 and the memory alloy wire 3 at the same time, the control circuit 6 may apply different voltages to the conductive wire 5 and the memory alloy wire 3. Generally, the voltage (for example, 15V) applied to the memory alloy wire 3 is higher than the voltage (for example, 5V) applied to the conductive wire 5, so that the temperature of the memory alloy wire 3 is quickly raised to reach the memory deformation temperature. At this time, a first regular deformation occurs to the memory alloy wire 3 for facilitating charging, such as a straight line or an arc line. In some cases, the voltage (for example, 15V) applied to the memory alloy wire 3 may also be lower than the voltage (for example, 36V) applied to the conductive wire 5, which will depend on the usage scenarios.

In other cases, the control circuit 6 can provide a current for the conductive wire 5 and the memory alloy wire 3 separately by switching the current flow. For example, when charging, the connection cable 1 may be manually pulled into the desired shape, and the control circuit 6 controls the current to flow into the conductive wire 5 to charge the mobile phone by the charging head. When the control circuit 6 is switched to provide a current for the memory alloy wire 3, the charging is cut off, and the temperature of the memory alloy wire 3 is raised to reach the memory deformation temperature. At this time, a second regular deformation occurs to the memory alloy wire 3 for facilitating winding, such as a helix line or a wavy line.

Furthermore, in the first mode, the control circuit 6 controls the voltage to be changed to reach a predetermined voltage so that the current of the memory alloy wire 3 is a suitable current and thus the temperature of the memory alloy wire 3 is raised to reach the memory deformation temperature, when the control circuit 6 does not recognize the current within a predetermined time period (for example, 10s). The predetermined voltage is an ideal voltage of the memory alloy wire 3. The electronic device is fully charged or the electronic device is unplugged from the plug connector at the other end, when the control circuit 6 does not recognize within a predetermined time period that the current passes through the conductive wire 5. At this time, the control circuit 6 changes the voltage so that the memory alloy wire 3 has a suitable current and thus the temperature of the memory alloy wire 3 is quickly raised to reach the memory deformation temperature.

Furthermore, in the second mode, the control circuit 6 controls the voltage to be changed to reach the predetermined voltage (for example, 15V) so that a suitable current passes through the memory alloy wire 3 and thus the temperature of the memory alloy wire 3 is raised to reach the memory deformation temperature, when the period of time that the conductive wire 5 is connected with the plug connector 2 reaches a predetermined period of time. The predetermined period of time may be set, for example, 20 minutes. When the charging is performed for 20 minutes, the control circuit 6 controls the voltage to be increased or decreased to reach the predetermined voltage, so that the temperature of the memory alloy wire 3 is raised adaptively to reach the memory deformation temperature.

In the first mode and the second mode, before the control circuit 6 controls the voltage to be changed, the control circuit 6 first disconnects the connection between the plug connector 2 and the conductive wire 5, and connects the plug connector 2 with the memory alloy wire 3, and then the control circuit 6 controls the voltage to be increased or decreased to reach the predetermined voltage, so that the voltage of the conductive wire 5 is a standard voltage when charging. The memory alloy wire 3 is connected when the charging is completed or the charging reaches a certain extent. The voltage change will not bring disadvantage to the battery of the mobile phone, thereby avoiding that the voltage change affects the performance of the battery of the electronic device.

When the predetermined voltage is reached for a predetermined period of time (for example, 5s), the memory alloy wire 3 is automatically deformed to achieve the winding effect, and the control circuit 6 controls the voltage to be decreased so that the temperature of the memory alloy wire 3 is decreased and thus the temperature of the memory alloy wire 3 is lower than the memory deformation temperature. More specifically, when the predetermined voltage is reached for the predetermined period of time (for example, 5s), the control circuit 6 disconnects the electrical connection between the memory alloy wire 3 and the electronic device, and the disconnection completely decreases the voltage to 0.

It is understood that, in the present invention, multiple memory alloy wires 3 may be arranged, and each memory alloy wire 3 may be individually provided with a current, and each memory alloy wire 3 is deformed into a different shape at its corresponding memory deformation temperature, which can obtain a data line that may be automatically deformed into multiple different shapes. Specifically, one memory alloy wire 3 may be automatically deformed to achieve a first regular deformation (such as a straight line) for facilitate charging, and another memory alloy wire 3 may be automatically deformed to achieve a second regular deformation (such as a spiral line) for facilitate winding.

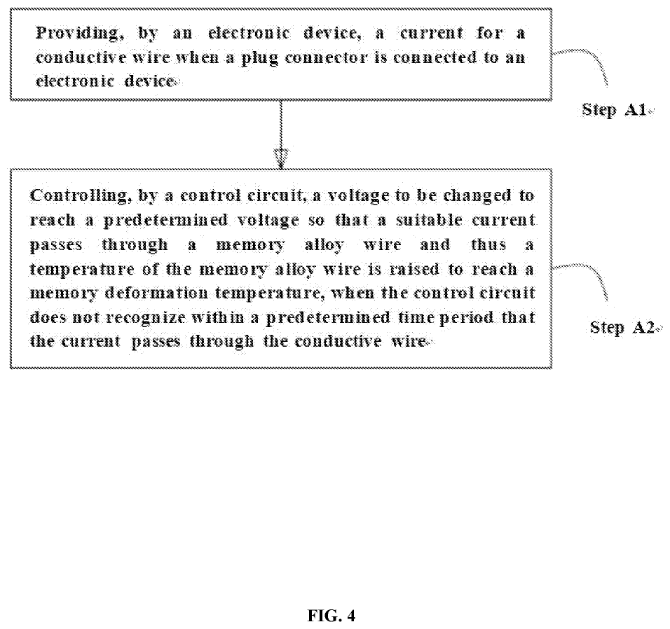

According to the above structure of the data line, the present invention provides a method for controlling the data line of the first embodiment, which includes the following steps A1 and A2, as shown in FIG. 4.

In step A1, an electronic device provides a current for a conductive wire 5 when a plug connector 2 is connected to the electronic device.

In step A2, the control circuit 6 controls the voltage to be changed to reach a predetermined voltage so that a suitable current passes through a memory alloy wire 3 and thus a temperature of the memory alloy wire 3 is raised to reach a memory deformation temperature, when the control circuit 6 does not recognize within a predetermined time period that the current passes through the conductive wire 5.

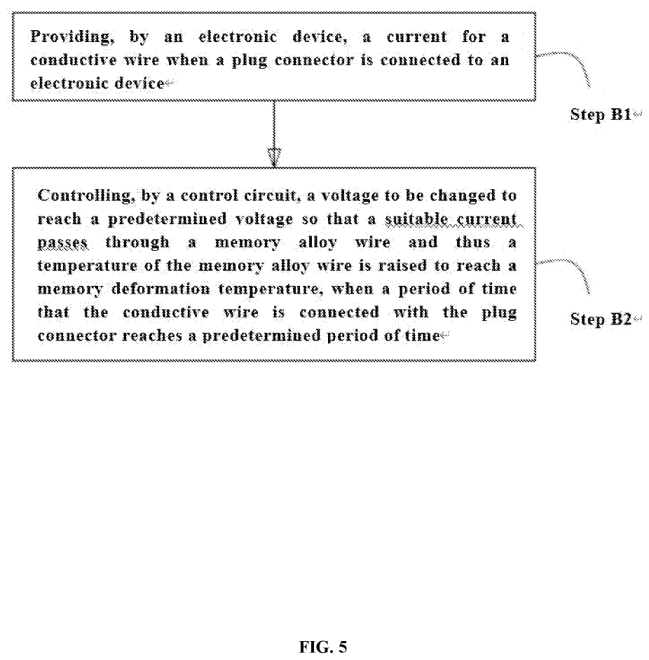

According to the above structure of the data line, the present invention provides a method for controlling the data line of the second embodiment, which includes the following steps B1 and B2, as shown in FIG. 5.

In step B 1, an electronic device provides a current for a conductive wire 5 when a plug connector 2 is connected to the electronic device.

In step B2, the control circuit 6 controls a voltage to be changed to reach a predetermined voltage so that a suitable current passes through a memory alloy wire 3 and thus the temperature of the memory alloy wire 3 is raised to reach a memory deformation temperature, when the period of time that the conductive wire 5 is connected with the plug connector 2 reaches a predetermined period of time.

The above are only the preferred embodiments of the present invention and are not intended to limit the present invention. Any modification, equivalent replacement and improvement made within the spirit and principle of the present invention shall be included within the protection scope of the present invention.

What is claimed is:

1. A data line with a memory function, wherein the data line comprises a connection cable, a plug connector arranged on the connection cable, and a control circuit electrically connected with the plug connector; the connection cable comprises a conductive wire and a memory alloy wire which are arranged along a length direction of the connection cable, the conductive wire and the memory alloy wire are electrically connected with the control circuit; the plug connector is configured to be connected to an electronic device, and the electronic device provides a current for the conductive wire and the memory alloy wire so as to raise a temperature of the memory alloy wire to reach a memory deformation temperature.

2. The data line with a memory function according to claim 1, wherein the control circuit controls the voltage to be changed to reach a predetermined voltage so that a suitable current passes through the memory alloy wire and thus the temperature of the memory alloy wire is raised to reach the memory deformation temperature, when the control circuit does not recognize within a predetermined time period that the current passes through the conductive wire.

3. The data line with a memory function according to claim 1, wherein the control circuit controls the voltage to be changed to reach a predetermined voltage so that a suitable current passes through the memory alloy wire and thus the temperature of the memory alloy wire is raised to reach the memory deformation temperature, when a period of time that the conductive wire is connected with the plug connector reaches a predetermined time period.

4. The data line with a memory function according to claim 2, wherein the control circuit controls the voltage to be decreased so that the temperature of the memory alloy wire is decreased and thus the temperature of the memory alloy wire is lower than the memory deformation temperature, when the predetermined voltage is reached for the predetermined time period.

5. The data line with a memory function according to claim 4, wherein the control circuit disconnects the electrical connection between the memory alloy wire and the electronic device, when the predetermined voltage is reached for the predetermined time period.

6. The data line with a memory function according to claim 2, wherein before the control circuit controls the voltage to be changed, the control circuit first disconnects the connection between the plug connector and the conductive wire, and connects the plug connector with the memory alloy wire.

7. A method for controlling a data line with a memory function, wherein the data line comprises a connection cable, a plug connector arranged on the connection cable, and a control circuit electrically connected with the plug connector; the connection cable comprises a conductive wire and a memory alloy wire which are arranged along a length direction of the connection cable, and the conductive wire and the memory alloy wire are electrically connected with the control circuit; the method comprises:
providing, by an electronic device, a current for the conductive wire when the plug connector is connected to the electronic device; and
controlling, by the control circuit, a voltage to be changed to reach a predetermined voltage so that a suitable current passes through the memory alloy wire and thus a temperature of the memory alloy wire is raised to reach a memory deformation temperature, when the control circuit does not recognize within a predetermined time period that the current passes through the conductive wire.

8. A method for controlling a data line with a memory function, wherein the data line comprises a connection cable, a plug connector arranged on the connection cable, and a control circuit electrically connected with the plug connector; the connection cable comprises a conductive wire and a memory alloy wire which are arranged along a length direction of the connection cable, and the conductive wire and the memory alloy wire are electrically connected with the control circuit; the method comprises:
providing, by an electronic device, a current for the conductive wire when the plug connector is connected to the electronic device; and
controlling, by the control circuit, a voltage to be changed to reach a predetermined voltage so that a suitable current passes through the memory alloy wire and thus a temperature of the memory alloy wire is raised to reach a memory deformation temperature, when a period of time that the conductive wire is connected with the plug connector reaches a predetermined period of time.

9. The control method of the data line with a memory function according to claim 7 wherein before the control circuit controls the voltage to be changed the control circuit first disconnects the connection between the plug connector and the conductive wire and connects the plug connector with the memory alloy wire
